(19) United States
(12) Patent Application Publication
(10) Pub. No.: US 2025/0315906 A1
(43) Pub. Date: Oct. 9, 2025

(54) GENERATIVE ARTIFICAL INTELLGIENCE PATENT CLAIM MAPPING

(71) Applicant: Black Hills IP Holdings, LLC, Minneapolis, MN (US)

(72) Inventor: Steven W. Lundberg, Edina, MN (US)

(21) Appl. No.: 19/173,546

(22) Filed: Apr. 8, 2025

Related U.S. Application Data
(60) Provisional application No. 63/631,154, filed on Apr. 8, 2024.

(51) Int. Cl. G06Q 50/18; G06F 40/177; G06F 40/284; G06F 40/295; G06F 40/30; G06N 3/0455; G06N 3/0475

(52) U.S. Cl. CPC G06Q 50/184; G06F 40/177; G06N 3/0455; G06N 3/0475; G06F 40/284; G06F 40/295; G06F 40/30

(57) ABSTRACT

A method may include receiving a plurality of claim texts corresponding to a plurality of claims originating from a patent document; identifying, using a generative artificial intelligence tool (generative AI tool), a common concept shared between a set of claim texts of the plurality of claim texts; presenting the common concept in a tabular form including a first column listing the common concept and additional columns corresponding to respective claim texts of the pluralities of claim texts indicating a presence or absence of the common concept; verifying, using a non-generative AI algorithm that the common concept has corresponding representations within the set of claim texts; and in response to the verifying, generating an interactive matrix, wherein the interactive matrix visually represents a relationship between the common concept and the set of claim texts.

This patent application claims the benefit of U.S. Provisional Patent Application No. 63/631,154, filed Apr. 8, 2024, which is herein incorporated by reference in its entirety

### BACKGROUND

The management of a patent portfolio involves multiple stages. Initially, a decision is made as to what inventions are worth the investment of filing a patent application. Then, each filed patent application goes through prosecution with the patent office. Finally, for each patent that is allowed, maintenance fees are usually payable at a variety of intervals to keep the patent in force. Quickly determining the scope and relevance of patent claims is important for efficiently managing a large portfolio of patents, allowing for accurate and streamlined assessments and timely decision-making.

### SUMMARY OF THE DISCLOSURE

In some aspects, the techniques described herein relate to a method for analyzing patent claims, implemented by a computer system, the method including: receiving a set of patent claim texts corresponding to a plurality of claims originating from one or more patent documents; processing the received patent claim texts with a generative artificial intelligence (AI) tool to identify common concepts shared among the set of patent claim texts; presenting the identified common concepts in a tabular format, wherein the table includes a first column listing the identified common concepts and additional columns corresponding to each patent claim text, each additional column indicating the presence or absence of the respective common concept in the corresponding patent claim text; applying a non-generative AI algorithm to cross-verify that the identified common concepts have corresponding representations within the respective patent claim texts; and generating an interactive matrix based on the verified common concepts and the patent claim texts, wherein the interactive matrix visually represents the relationship between the common concepts and the patent claim texts.

In some aspects, the techniques described herein relate to a computer-implemented method including: receiving a patent portfolio including a plurality of patent documents each having one or more patent claims; mapping the one or more patent claims to one or more scope concepts using a generative artificial intelligence model, each of the one or more scope concepts defining a scope to which a patent claim is limited; storing an indication of a relationship between the one or more scope concepts and the one or more patent claims in a database of patent claims; highlighting one or more claim terms in the one or more patent claims associated with the one or more scope concepts; and displaying the one or more mapped patent claims and the one or more highlighted claim terms to a user in a graphic user interface, wherein the graphical user interface includes a scope modification interactive graphical user interface element.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 is a system component diagram, according to various examples.

FIG. 2 is a block diagram of a patent management system, according to various examples.

FIG. 3 is a schematic diagram of a user interface for generative artificial intelligence driven patent portfolio analysis and patent claim mapping, according to various examples.

FIG. 4 is a schematic diagram of a user interface for generative artificial intelligence driven patent portfolio analysis and patent claim mapping, according to various examples.

FIG. 5 is a system including a generative artificial intelligence tool for patent claim mapping, according to various examples.

FIG. 6 is a method of using a generative artificial intelligence tool for patent claim mapping, according to various examples.

FIG. 7 is a block diagram of a generative artificial intelligence tool for patent claim mapping, according to various examples.

FIG. 8 is a flowchart illustrating a method to use a generative AI tool to identity a common concept, according to various examples.

FIG. 9 is a computer system on which the methods described herein may be executed, according to various examples.

### DETAILED DESCRIPTION

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

Tools for identifying patents for a particular purpose such as a prior art search, validity analysis, or a freedom to operate investigation, operate by performing Boolean queries using various search operators. These operators allow for searching by date, terms, document number, and patent classification, among others. These tools further allow for searching individual document portions such as a document title, abstract, or claim set.

Other searching tools accept freeform text input, extracting information from these text blocks that are most likely to return acceptable results. However, these tools often remain limited to performing Boolean queries and displaying a list of results

These search tools often provide large numbers of results, most of which are irrelevant. These tools fail to present results in a manner allowing for quick relevancy determinations. The presentation also fails to provide enough detail suggesting how to adjust a search for obtaining only relevant results. Further, the search tools provide the documents of the result set in a manner very similar to the traditional paper format of the documents. Quickly determining the scope and relevance of patent claims is essential for efficiently managing a large portfolio of patents, allowing for accurate and streamlined assessments and timely decision-making.

Discussed herein is a method of patent claim mapping, where a portfolio of patents is automatically analyzed by a generative AI tool to produce a dynamic patent claim map based on automatically generated and verified scope concepts. A scope concept may define the scope to which a patent claim is limited. For example, if a claim recites “a surface having four indentations and a glossy surface” a scope concept a scope concept may be “a surface an indentation.” Thus, if a person was analyzing their products that person would know that if the product did not have a surface with an indentation, it would not read on the claim regardless of the other elements. This disclosure may also use the term common concept. A common concept may be a scope concept that is shared across at least two patent claims. A scope concept is not simply a summary of a patent claim as a summary may not be definitive enough to indicate what a claim is or is not limited to.

Here, a patent portfolio is provided. The portfolio may be automatically retrieved or may be received by the generative AI tool. The claims in each of the plurality of patents in the portfolio may be received as text. In some cases, the tool automatically scrapes the patent claim text for this analysis. Once received, the AI tool may analyze the claim text for scope concepts. The tool may, for example, review and analyze overlapping language and concepts in the claims of each of the documents in the patent portfolio.

Based on this analysis, the generative AI tool may generate the scope concepts. The AI tool may present these scope concepts to a user on a user interface. The AI tool may receive user feedback or proceed through automated quality-control review of the scope concepts produced. Here, the produced scope concepts may be verified, cross-checked, and confirmed as desired scope concepts.

Once confirmed, the tool may compare the scope concepts across each desired claim in the patent documents of the patent portfolio. For example, in a claim of a first patent, the tool may confirm which scope concept(s) are present in the claim. This mapping may be done throughout the portfolio, such as for independent claims.

The tool may produce a dynamic, visual map on the user interface, that conveys this claim-to-scope-concept mapping. This may be, for example, a document such as a spreadsheet, which automatically updates as a user interacts with it, and if/when scope concepts are updated or patents are added to the portfolio. The produced visual map may have an interactive portion, such as a button, that may initiate an update to the visual map.

As used herein, “application” or “program” may include a program or piece of software designed and written to fulfill a particular purpose of the user, such as a database application.

As used herein, “artificial intelligence “AI” may refer to the use of computer systems to perform tasks such as visual perception, speech recognition, translation, decision-making, and other tasks based on training data

As used herein, “machine learning” refers to artificial intelligence used in statistical algorithms to generalize and then perform tasks without specific instructions but based on training.

As used herein, “generative artificial intelligence” may refer to algorithms capable of generating text, images, or other media, such as by learning patterns and structure of training data and then producing text, image, or other media output based on the learned patterns.

As used herein, “official record” or “file history” may refer to data about a file or matter denoting evidence about past events or tasks within that file or matter, such as an electronic record of previous events in the file or matter. An “official record” may be stored with and maintained by an overseeing agency or organization, such as a governmental organization.

As used herein, “practitioner” or “patent practitioner” may refer to a patent attorney, patent agent, or other patent prosecution practicing personnel licensed in the relevant jurisdiction.

As used herein, “scraping,” “web scraping,” “data scraping,” or “web crawling” may refer to automatically mining or collecting data or information, such as from a network-accessible database via APIs or from webpages.

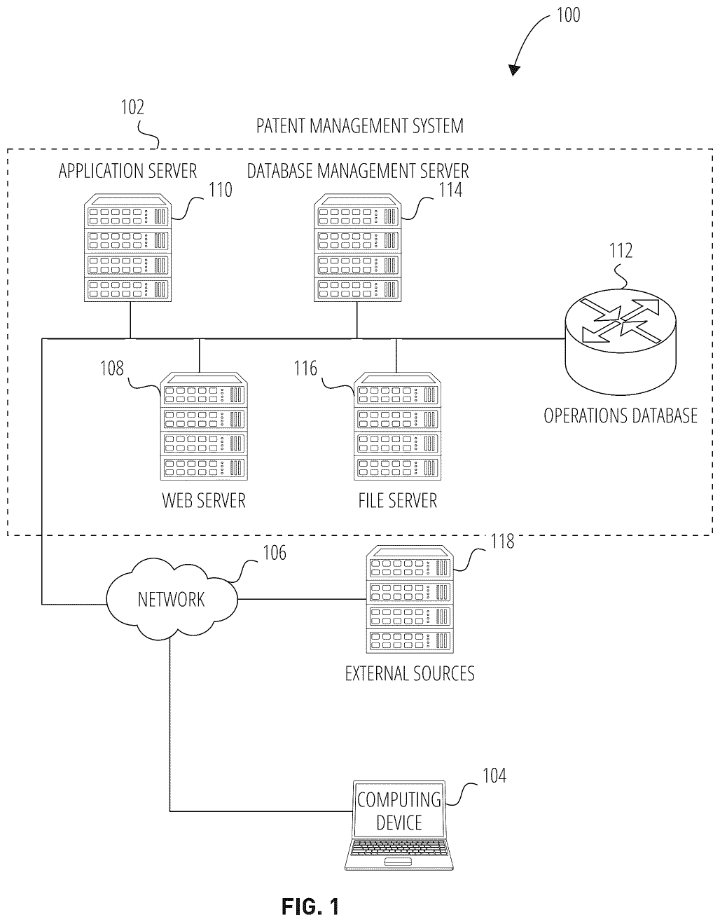

FIG. 1 is a schematic view of computer network system 100, according to various examples. The computer network system 100 includes a patent management system 102 and computing device 104, communicatively coupled via network 106. As illustrated, the patent management system 102 includes web server 108, application server 110, and database management server 114, which may be used to manage at least operations database 112 and file server 116.

Patent management system 102 be implemented as a distributed system; for example, one or more elements of the patent management system 102 may be located across a wide-area network (WAN) from other elements of patent management system 102. As another example, a server (e.g., web server 108, file server 116, database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices/systems coupled to network 106 may be coupled to network 106 via one or more wired or wireless connections.

Web server 108 may communicate with file server 116 to publish or serve files stored on file server 116. Web server 108 may also communicate or interface with the application server 110 to enable web-based applications and the presentation of information. For example, application server 110 may consist of scripts, applications, or library files that provide primary or auxiliary functionality to web server 108 (e.g., multimedia, file transfer, or dynamic interface functions). Applications may include code, which, when executed by one or more processors, runs the tools of patent management system 102. In addition, application server 110 may also provide some or the entire interface for web server 108 to communicate with one or more of the other servers in patent management system 102 (e.g., database management server 114).

Web server 108, either alone or in conjunction with one or more other computers in patent management system 102, may provide a user interface to the computing device 104 for interacting with the tools of patent management system 102 stored in application server 110. The user interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

The computing device 104 may be a personal computer or mobile device. Ives, computing device 104 includes a client program to interface with patent management system 102. The client program may include commercial software, custom software, open-source software, freeware, shareware, or other types of software packages. In an example, the client program includes a thin client designed to provide query and data manipulation tools for a user of the computing device 104. The client program may interact with a server program hosted by, for example, web server 108. Additionally, the client program may interface with the database management server 114.

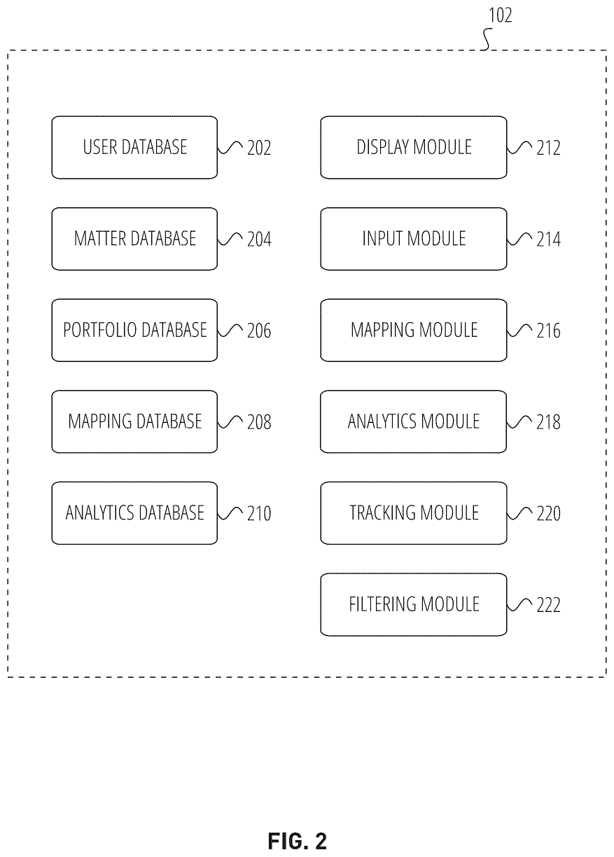

Operations database 112 may be composed of one or more logical or physical databases. For example, operations database 112 may be viewed as a system of databases that when viewed as a compilation, represent an “operations database.” Sub-databases in such a configuration may include a matter database, a portfolio database, a user database, a mapping database and an analytics database (for examples, see FIG. 2). Operations database 112 may be implemented as a relational database, a centralized database, a distributed database, an object-oriented database, or a flat database.

In various examples, the functionality and electronic communication of the patent management system 102 define a common framework. The framework may have a base organization unit of a “matter.” In various examples, a matter is an issued patent or patent application that includes one or more patent claims. For example, a matter is generally identified by its patent number or publication number. Identification may mean either identification as it relates to a user of the patent management system 102 or within the patent management system 102. Thus, a user may see a matter listed as its patent number-while internally a database of the patent management system 102 may identify the matter by a random number. A mapping may be stored that links the external presentation with the randomized internal representations. A matter may be associated (e.g., via primary and secondary keys in a relational database) with prior art or cited references stored in a reference or prior art database.

Matters may be grouped together to form a “portfolio.” A matter may also be associated with one or more other matters in a family. A family member may be a priority matter, a continuing (e.g., continuation, divisional) matter, or a foreign counterpart member. Family members may be determined according to a legal status database such as INPADOC.

Data stored in a first database may be associated with data in a second database through the use of common data fields. For example, consider entries in the matter database formatted as [Matter ID, Patent Number] and entries in the portfolio database formatted as [Portfolio ID, Matter ID]. In this manner, a portfolio entry in the portfolio database is associated with a matter in the matter database through the Matter ID data field. In various examples, a matter may be associated with more than one portfolio by creating multiple entries in the portfolio database, one for each portfolio that the matter is associated with. In other examples, one or more patent reference documents may be associated with a patent by creating multiple entries in the patent database. The structure of the database and format and data field titles are for illustration purposes, and other structures, names, or formats may be used. Additionally, further associations between data stored in the databases may be created as discussed further herein.

During operation of patent management system 102, data from multiple data sources (internal and external) is imported into or accessed by the operations database 112. Internal sources may include data from the various tools of the patent management system 102. External sources 118 may include websites or databases associated with foreign and domestic patent offices, assignment databases, WIPO, and INPADOC. In various examples, the data is scraped and parsed from the websites if it is unavailable through a database. The data may be gathered using API calls to the sources when available. The data may be imported and stored in the operations database on a scheduled basis, such as daily, weekly, monthly, quarterly, or some other regular or periodic interval. Alternatively, the data may be imported on demand. The imported data may relate to any information pertaining to patents or patent applications, such as serial numbers, title, cited art, inventor or assignee details.

After data importation, the data may be standardized into a common format. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats and name formats).

FIG. 2 is a block diagram of patent management system 102, according to various examples. The number and functionality of the modules are examples of the implementation of a patent management system 102, and other implementations may be used. Patent management system 102 of FIG. 2 is illustrated as including user database 202, matter database 204, portfolio database 206, mapping database 208, analytics database 210, display module 212, input module 214, mapping module 216, analytics module 218, tracking module 220 and filtering module 222.

FIG. 2 is illustrated and discussed as separate elements (e.g., modules and databases). However, the functionality of multiple individual elements may be performed by a single element. An element may represent computer program code executable by a processing system. The program code may be stored on a storage device (e.g., operations database 112) and loaded into the memory of the processing system for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

In various examples, the data stored in the databases may be in the same or multiple physical locations. For example, portfolio database 206 may be stored in one or more computers associated with a portfolio management service. In various examples, patent management system 102 mirrors databases stored in other locations. In an example, when a request is made to access data stored in one of the databases, patent management system 102 determines where the data is located and directs the request to the appropriate location.

Various examples modules 212 to 222 are shown and discussed in U.S. Pat. No. 11,775,538, which is herein incorporated by reference in its entirety. The generative artificial intelligence tool used for patent claim mapping discussed herein may, for example, be part of one or more of these modules, such as the mapping module 216 and the analytics module 218 or be a separate module.

In various examples, mapping module 216 maps scope concept, technology categories, prior art, and keywords to patent claims of a matter. In an example, mapping signifies association. For example, in conjunction with display module 212, input module 214, mapping module 216 may present a user interface of patent claims stored in matter database 204 and scope concepts stored in mapping database 208.

Input module 214 (via web server 108) may receive a selection of one or more patent claims and one or more scope concepts and pass them to mapping module 216. Mapping module 216 may then formulate an SQL query to associate the one or more patents claims with the one or more scope concepts. When executed, the SQL query may update the mapping database 208 with the associations. In various examples, mapping module 216 also allows the creation of new scope concepts, technology categories, and keywords that may be mapped to one or more patent claims. Furthermore, mapping module 216 may present user interfaces that allow a user to rank and rate matters stored in matter database 204.

Mapping module 216 may also allow the generation of claim charts of a plurality of cells. A claim chart may include one or more scope concepts, technology categories, and keywords on one axis and claims of matters in a portfolio on the other axis. The claim chart may include a variety of levels of granularity of scope concepts. Some claims may be mapped to all of the scope concepts while others may not be mapped to any scope concepts. At the cell intersection between a scope concept (or technology category or keyword) and a claim, an indication of the mapping may be presented by changing the format of the cell. For example, the cell may be colored blue when a scope concept is mapped and red when not mapped.

In various examples, and as explained in more detail further below, a freedom-to-operate (FTO) analysis may be facilitated using the mapping module 216 to generate claim charts. For example, a series of scope concepts mapped as being present in a claim may themselves be further mapped as being present (or not) in a competitive product. If all the scope concepts in a given claim, representing all the claim elements in that claim, are found present in a product, an indication of “likely infringement” may, for example, be indicated in the claim chart accordingly. Red or green colored cells in a claim chart could, for example, respectively represent instances of when scope concepts are found present (or mapped) in a product, and when not. If the product being assessed was the patentee's own product, a “product coverage” chart could be generated in a similar way.

So too a similar approach may be undertaken for validity analysis in which scope concepts are mapped to body of prior art instead of a product, for example. A green-colored cell in a “validity” claim chart might indicate a novel concept, for example, while a red-colored cell might indicate prior disclosure.

In various examples, any one or more of the modules may be configured to perform patent searches. For example, mapping module 216 may formulate an SQL query to search for one or more keywords or scope concepts in some prior art. The module may be configured to expand the search automatically, for example based on synonyms, forward or reverse citations, or other criteria. In this way, a seed group of patents may be identified and then expanded automatically.

The claim charts referred to above and in further detail below may be termed “Panoramic Claim Charts” in that they quickly provide to a user a panoramic display in summary overview the findings and conclusions of a mapping exercise, whether the analysis be of FTO, product coverage or validity type. For such charts or spreadsheets, further concept organization may be undertaken.

In the context of a “Panoramic Claim Chart” methodology for concept organization, a meta-label sorting mechanism is implemented to systematically categorize concepts under designated meta-labels. These meta-labels may function analogously to scope concept groups. In various implementations, scope concept groups are incorporated by the mapper (either human operator or computational system) to systematically organize the resultant map output according to these established groups. Furthermore, the mapper possesses the capability to determine and specify the sequential presentation of scope concepts, and to preserve this organizational structure for subsequent utilization. The mapper additionally retains the discretionary authority to conceal concepts as deemed appropriate.

In certain implementations, mapping module 216 propagates mapping hierarchically from independent claims to their dependent claims. Consequently, independent claim limitations, scope concepts, or technology categories are incorporated into dependent claims as appropriate and may be presented accordingly within the Panoramic Claim Chart. Dependency relationships may be established either through formally defined claim dependencies within a given claim set, or through mapper-defined relationships established during analysis, notwithstanding the absence of formal definition within the claim set under examination.

In various implementations, keyword clustering methodologies are employed to enhance claim mapping efficacy. This approach may be characterized as a “clustered” search or mapping, with mapping module 216 configured accordingly. In an exemplary implementation of clustered mapping, the mapping module 216 and display module 212 may be jointly configured to render a user interface within a mapping application tool (designated as “ClaimBot,” for instance) incorporating a user interface element or mapping functionality referred to as “OmniMap.” The selection of this functionality initiates a search operation to identify similar claims.

This functionality necessitates comprehensive knowledge regarding the content of the subject patent portfolio and deliberate refinement of search parameters to isolate claims of a similar nature into a consolidated list prior to the mapper's definitive determination regarding the applicability of certain scope concepts to each claim. The application of identical concepts across multiple claims is highly advantageous. Both portfolio content familiarity and search parameter development require substantial time investment. A more optimized methodology is discussed next.

In various implementations, upon selection of a designated user interface element (termed “IntelliMap,” for instance), a keyword search functionality is activated wherein the mapping module 216 is configured to execute portfolio-wide searches for source claim(s) keywords, thereby expediting search processes and facilitating multi-word keyword string utilization. The system may optionally display the source claim(s) keywords within a modal dialog interface where the user may designate relative significance of individual terms or term groupings (sub-clustering). The mapping module 216 conducts portfolio-wide searches for source claim keyword occurrences, optionally employing keyword stemming, synonym reference databases, pre-established taxonomies/dictionaries, or semantic processing methodologies, and subsequently generates a results list of claims sorted according to source claim keyword occurrence frequency within the analyzed claims, or alternatively, weighting this occurrence frequency against predetermined relative importance values of the source claim keywords.

This methodology establishes a systematic mapping procedure as follows:
1. Select one or more representative claims from the portfolio to serve as source claims.
2. Automatically extract pertinent keywords from the designated source claims.
3. Optionally, establish hierarchical importance relationships among extracted keywords.
4. Implement IntelliMap functionality for selected keywords.
5. Optionally apply automated keyword stemming, synonym reference databases, pre-established taxonomies/dictionaries, or semantic processing methodologies.
6. Execute portfolio-wide claim searches utilizing identified keywords.
7. Generate a hierarchical listing of identified claims sorted by keyword occurrence frequency.
8. Optionally (1), modify sorting parameters weighted against established keyword importance hierarchy.
9. Optionally (2), the mapper may further refine the resultant claim list utilizing current search functionality, e.g., implementing “!” (NOT) operators to exclude specific claims.
10. The mapper may subsequently examine the result set to identify common conceptual elements and map these to the appropriate claims.

Automated aggregation of similar claims, as described herein, facilitates mapping processes through organizational clustering of claims based on keyword content analysis. The mapper may more efficiently identify candidate concepts within the searched claim set and immediately access a comprehensive claim list for concept mapping without necessitating explicit search string formulation. This methodology operates on the fundamental premise that claims substantially employ identical or semantically related terminology (e.g., synonyms, word stems).

In various examples, a claim similarity index is provided. A claim similarity index identifies claims to map scope concepts to. The similarity of a sub-paragraph (or element) of a claim or a full claim may be measured by: a) keyword similarity-roots of words are compared after throwing out unimportant words; b) linguistic analysis-how similar or not claim elements are based on other approaches. In one implementation, the mapping module 216 is configured to suggest to users mapping claims which claims are most similar to one another, or what parts of claims are most similar to one another. In another implementation, claims are just flagged as similar for later use.

In various examples, when mapping claims (for example, using the Omnimap feature mentioned above), a user is allowed to highlight the claim terms associated with a scope concept across a number of claims, storing those associations, and then when subsequently displaying those claims (for example, in the Panoramic Claim Chart) showing which claim terms have already been mapped.

In various examples, those terms are highlighted in different colors for better visualization. This feature is helpful in situations in which a mapper moves to map another patent and has already mapped portions of claims. The highlighting makes it easier for the mapper to see what he or she has mapped. In some examples, the mapping module 216 is configured to automatically identify common claim terms or elements and display this in a user interface so these elements may be mapped more quickly. In some examples, the mapper may define common claim terms or filter them based on unique words or phrases of a certain number of words.

In some examples, an aid in mapping claims to a product is provided. Instead of using a claim chart, the mapping module 216 and display module 212 are configured together to show claims parsed by paragraph. Next to each paragraph, a mapper may indicate if the product includes the technology described in the claim. The same logic used in scope concept mapping is used to determine if claim is ruled out in an FTO analysis, or is novel in a validity analysis, for example.

In various examples, analytics module 218 examines and runs calculations on the data stored in the database of patent management system 102 to generate the analytics previously discussed. For example, analytics module 218 may formulate an SQL query that retrieves the number of times that a prior art reference has been cited within a portfolio. This query may be run for each prior art cited within the portfolio to determine a list of the most cited (e.g., the top ten) prior art references with a portfolio. In an example, the queries are formulated and run as requested by a user.

Ives, once the analytics information has been determined, it is stored within analytics database 210. In various examples, queries are formulated and run on a periodic basis (e.g., nightly) and entries in analytics database 210 may be updated to reflect any changes. The analytics module 218 may, in response to user input, formulate a query to examine how many times a given patent matter has been assigned or been subject to a change in ownership from one party to another. Other queries analyzing patent assignment data may be run as requested by a user.

In various examples, the analytics module 218 analyzes and maps cited reference data stored in the matter database 204. The data may be scraped in by the input module 214. For example, cited references owned by or cited against a target or other entities, as mentioned above, may be mapped against each other to determine a “prior art” overlap. The overlap may be presented graphically, for example in a graphic user interface presented in computing device 104. In various examples, the overlap may relate to so-called “forward” citations, or “reverse” citations, or both. In various examples, the overlap may be presented for a target company and one or more competitors. Changes in the overlap over time may also be stored and mapped to give an indication to a user of technology trends, changes in trends and the ongoing development of potentially relevant prior art. In various examples, a prior art overlap between a target and competitor may be stored, mapped, and shown for a single patent, a portfolio of patents, or a family of patents. The target and other entities of interest, such as competitor companies or inventors, may be selected by the user.

An analytical result or mapping may be displayed as a list of prior art cited against both the target and competitor, with an indication of which art overlaps or is common to both listings. In various examples, the analytical result or mapping may, in addition, or alternatively, present a list of companies that own the prior art cited against the target and other entities. The target company may appear as an owner. The display module 212 may display the results of the mappings and overlap of cited references as a bar chart, listings, or another graphic in a user interface.

In various examples, the analytics module 218 is to receive input identifying a pool of keywords for a first patent matter in matter database 204 and associated prior art documents in matter database 204. The term keyword is intended to include individual keywords as well as a number of keywords grouped together making up a key phrase, for example. The analytics module 218 may be further to perform a keyword analysis on the first patent matter and associated prior art documents based on occurrences of the keywords in the first patent matter and associated prior art documents. The analytics module 218 may be further to identify, based on the analysis, keywords occurring uniquely in the first patent matter. In view of their uniquely occurring nature, these keywords may be regarded as claim elements potentially differentiating the claim set or statement of the invention over the disclosures contained in one or more prior art documents.

In various examples, the analytics module 218 generates, for a user, the patent activity profiles of various entities. The entities may be competitive entities to the user, or the user's employer or client. The generated activity profiles may form part of the information to assist in the strategic monitoring of patent portfolios. A patent activity profile may be built for a particular patent applicant or owner or a type of owner, and then deviances from that profile may be flagged. The profile may include foreign filing patterns and US filing patterns-for example, analyzing whether the owner typically files a provisional application first, followed by a PCT application, or whether a US application is typically filed thereafter. The profile may include information about abandonments-for example, identifying what subject matter an owner gives up or surrenders during prosecution, or in making abandonment decisions.

In various examples, the profile may include information about instances or circumstances in which an owner does not pay a patent annuity or renewal fee. The profile may include any of the data stored in analytics database 210 referred to above. Analytics module 218 may be to flag deviances from a profile and send update alerts to a user accordingly. For example, in conjunction with display module 212 and input module 214, analytics module 218 may present to a user an interface indicating one or more patent activity profiles for one or more patent owners for the user to select and review.

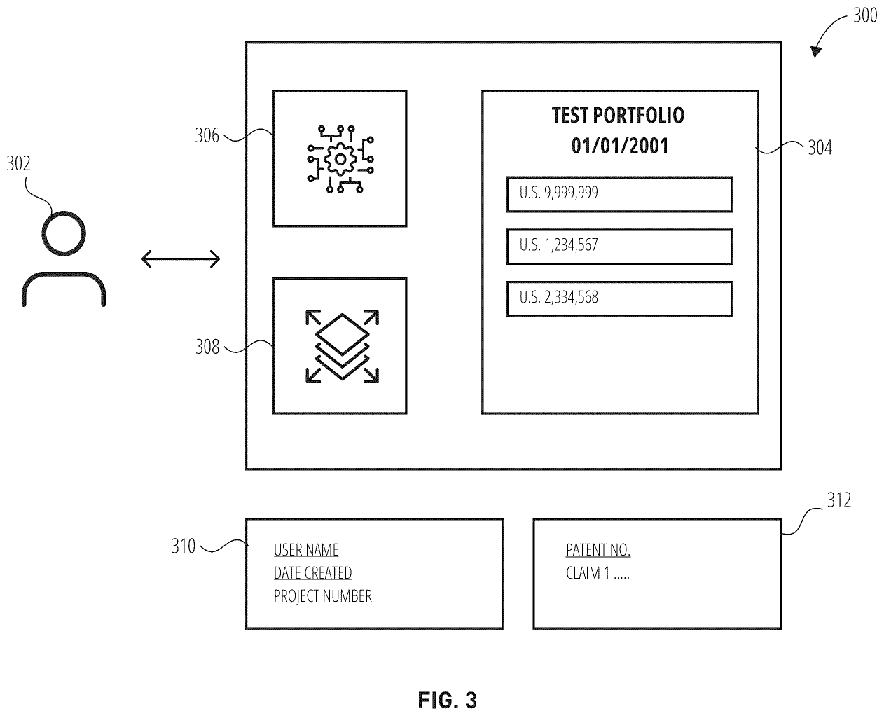

The patent management system 102, including the various databases and modules may include the generative artificial intelligence tool (generative AI tool) discussed herein, such as for use in patent portfolio claim scope analysis. An example generative AI tool and associated methods of patent portfolio claim scope analysis are discussed below with reference to FIG. 3 to FIG. 9.

FIG. 3 is a schematic diagram of a user interface 300 for generative artificial intelligence driven patent portfolio analysis, according to various examples. A user 302 may interact with the user interface 300. The user interface 300 may include one or more windows, such as windows for portfolio overview 304, analytics tool element 306, mapping tool element 308, bibliographic information 310, and patent information 312.

The portfolio overview 304 window may include information such as a list of documents in the portfolio and identifying numbers for each document. The portfolio overview 304 may additionally include information about the portfolio itself, such as a title, date created, date modified, and number of documents therein. The portfolio overview 304 may allow for a user to easily see an overview of the portfolio they are working on.

The analytics tool element 306 may, for example, be a UI element, such as a button or menu, that, when activated, may take the user to an interface for analytics of the patent portfolio. Such analytics cases include, for example, generative AI-driven review, analysis, comparison, and scoping of patent documents, such as described above with reference to FIG. 2. In an example, the analytics tool element 306 may be for the generative AI-driven production of scope concepts for further claim analysis.

The mapping tool element 308 may, for example, be a UI element, such as a button or menu, that, when activated, may take the user to an interface for production of a patent map, such as a claim map.

The bibliographic information 310 may include, for example, file numbers, associated parties, such as assignee, inventor, or other, dates associated with the file, such as filing dates, priority dates, or others. The patent information 312 may similarly show pertinent information on the user interface, such as patent claims, claim counts, figures, specification, or other information about the patent file.

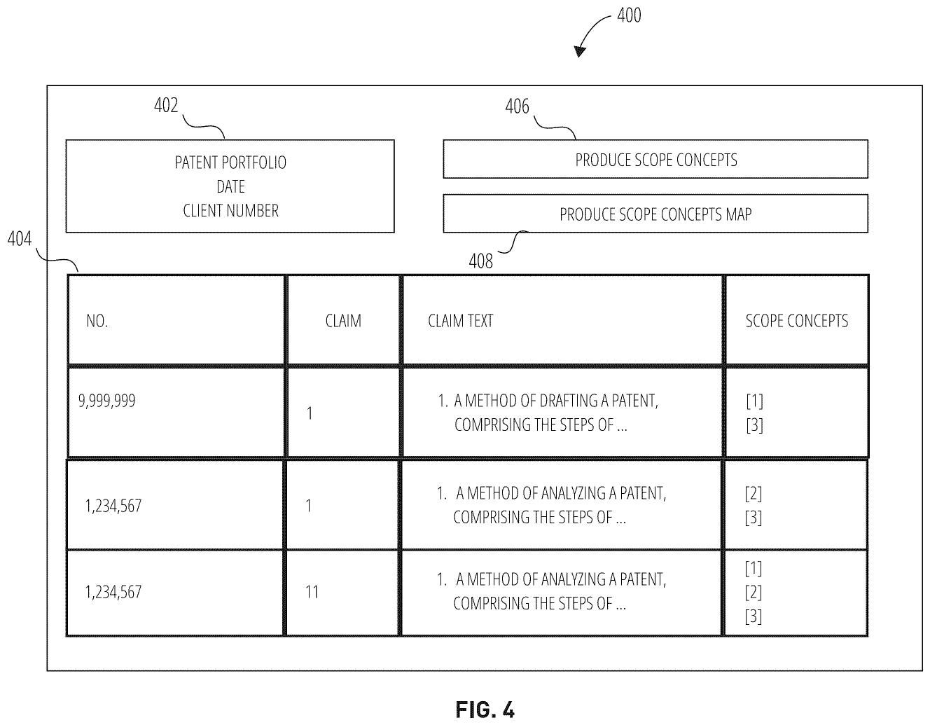

FIG. 4 is a schematic diagram of a user interface 400 for generative artificial intelligence driven patent portfolio analysis, according to various examples. As presented, the user interface 400 may include bibliographic data 402, patent list 404, and user-interactive button 406 and user-interactive button 408. User-interactive button 406 and user-interactive button 408 may be used to submit a request to an AI tool, such as to produce scope concepts or to produce a scope concepts map as discussed herein.

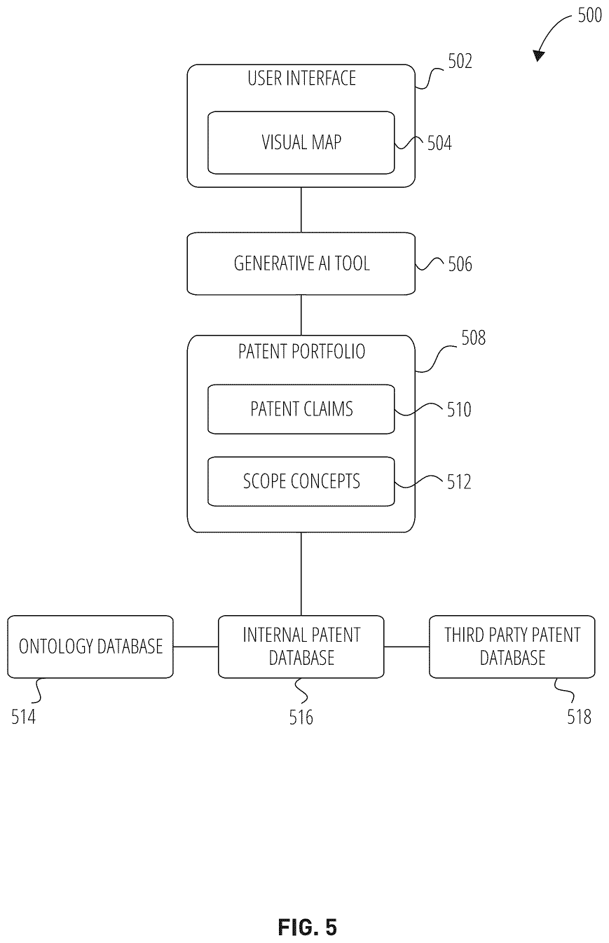

FIG. 5 is a system 500 including a generative artificial intelligence tool for patent claim mapping, according to various examples. The system 500 may include the user interface 502 with visual map 504, generative AI tool 506, patent portfolio 508 with patent claims 510 and scope concepts 512, ontology database 514, internal patent database 516, and third party patent database 518.

The user interface 502 may, for example, include screens such as those discussed above with reference to FIG. 3 to FIG. 4. The user interface 502 may be where a scope concepts map is presented to a user.

The generative AI tool 506 may be a generative artificial intelligence tool for analysis of patent portfolios, patent claims, production of claim scope concepts, and production of interactive scope concept maps. The generative AI tool 506 may interface with the patent portfolio 508, and produce the visual map 504 and scope concepts on the user interface 502.

The patent portfolio 508 may be the portfolio in which the user is working. For example, the portfolio may include a multitude of patent applications, publications, or other such materials, including domestic documents, foreign documents, PCT documents, or all of the above. Each of the documents in the patent portfolio 508 may include patent claims (e.g., patent claims 510) which may be analyzed using the generative AI tool 506.

The scope concepts 512 may be generated by the generative AI tool 506 based on the patent claims 510 in the patent portfolio 508 in conjunction with the ontology database 514. In some cases, patent documents may be populated in the patent portfolio 508 with the internal patent database 516 and the third party patent database 518, which may be scraped by the generative AI tool 506 accordingly.

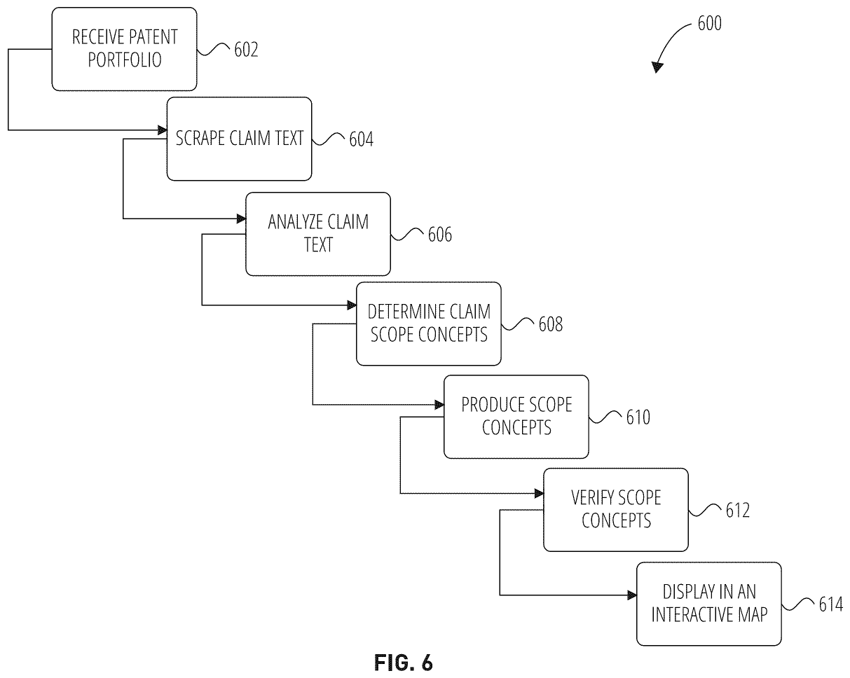

FIG. 6 is a method 600 of using a generative artificial intelligence tool for patent claim mapping according to various examples.

At block 602, a patent portfolio may be received by the generative AI tool. In some cases, the patent portfolio may be premade. In some cases, the patent portfolio may be uploaded by a user. In some cases, the generative AI tool may receive a list of patent documents, such as identifying numbers, and retrieve the desired documents, such as through interfacing with an internal or external patent database. For example, such scraping and production of the patent portfolio may be done automatically.

The generative AI tool may operate as an electronic service that receives data through an application programming interface (API) and may execute either locally on a user's computing device 104 or in a network environment, such as on application server 110 or web server 108 as illustrated in FIG. 1. The generative AI tool may include a generative AI model as shown in FIG. 5 as the generative AI tool 506.

Executing the generative AI model may include providing instructions (e.g., a prompt) to the model to produce a desired output in a desired format. A prompt, in the context of generative artificial intelligence, may comprise a sequence of tokens (e.g., words, characters, or subword units) that serves as an input instruction set to guide the model's generation process. The prompt may include natural language instructions specifying the tasks to be performed (e.g., “identify common concepts across these patent claims” or “generate a tabular representation of scope concepts”), along with formatting requirements, output constraints, and examples of desired outputs.

The context used for the generative artificial intelligence model may include the patent documents identified in the patent portfolio 508. In generative AI architecture, context refers to the input sequence and any additional information provided to the model that influences its generation process. This context may include the full text of patent claims 510, associated metadata, previously generated outputs, and system-level instructions that define the operational parameters of the generative process. The model processes this context through its transformer-based architecture, utilizing attention mechanisms to identify relevant patterns and relationships within the input data.

The patent documents may be tokenized and encoded into numerical representations that can be processed by the model's neural network layers. These documents may be stored in and retrieved from the internal patent database 516 or third party patent database 518 as shown in FIG. 5. The generative AI model may leverage information stored in the ontology database 514 to enhance its analysis of the patent claims 510. This ontology information may be incorporated into the context window, providing domain-specific knowledge that improves the model's ability to recognize and categorize technical concepts within the patent claims.

The model may use various techniques such as few-shot or zero-shot learning to adapt to the specific patent analysis task, where the model utilizes its pre-trained knowledge of patent language and structure to generate relevant outputs even with minimal task-specific training examples. As shown in FIG. 2, the generative AI tool may operate in conjunction with the mapping module 216 and analytics module 218 to generate the scope concepts and display them through the display module 212.

At block 604, the generative AI tool may scrape claim text from the patent documents in the patent portfolio. For example, the generative AI tool may retrieve the independent claims, dependent claims, or both, from gathered patent documents. In some cases, the claim text may be retrieved directly from one or more patent databases.

At block 606, the generative AI tool may analyze the claim text. For example, the generative AI tool may analyze overlapping claim language, overlapping claim concepts, and other markers within the claim text. This analysis may involve multiple computational approaches implemented within the generative AI architecture. The model may perform lexical analysis to identify recurring terminology across the patent claims, semantic analysis to determine conceptual similarities despite varying language, and structural analysis to recognize common claim element patterns across different patents.

The analysis may utilize transformer-based mechanisms that calculate attention weights across token representations of the claim text, enabling the model to identify correlations between distant elements within the same claim and across different claims in the portfolio. The generative AI tool may employ natural language processing techniques such as named entity recognition to identify technical components, functional descriptors, and operational constraints within the claim language. Additionally, the tool may implement part-of-speech tagging to distinguish between nouns representing components, verbs describing actions or functions, and adjectives specifying attributes or characteristics.

The generative AI tool may further apply topic modeling algorithms to cluster related terminology and identify thematic patterns across the claims. This may include techniques such as Latent Dirichlet Allocation (LDA) or more advanced neural topic modeling approaches integrated within the transformer architecture. The model may calculate similarity metrics between claim elements using vector space representations (embeddings) of the claim text, allowing for quantitative measurement of conceptual overlap. These similarity calculations may utilize cosine similarity between embedding vectors or more sophisticated distance metrics that account for the specialized language of patent claims.

The tool may reference the ontology database 514 shown in FIG. 5 during this analysis to incorporate domain-specific knowledge, technical hierarchies, and standard terminology, thereby enhancing its ability to recognize equivalent technical concepts expressed using different terminology across multiple patents. The analysis may also involve temporal considerations, tracking how certain claim concepts evolve across a patent family or change over time within a portfolio.

At block 608, the generative AI tool may determine one or more claim scope concepts based in its analysis of the claim language. The determination of scope concepts represents a high-level abstraction of the technical contributions identified across multiple patent claims. The model may generate these scope concepts through a multi-stage process that involves aggregation of similar elements identified during analysis, hierarchical classification of identified concepts, and distillation of core technical principles that define the inventive scope.

The model may implement rule-based heuristics derived from patent examination guidelines to identify elements that typically define patentable scope, such as novel combinations of components, specific operational parameters, or particular methods of implementation. These heuristics may be encoded in the prompt engineering for the generative AI model or incorporated as part of the system's procedural framework.

At block 610, the generative AI tool may produce those scope concepts, such as on a user interface for interaction with a user. The production of scope concepts may involve rendering the conceptual analysis into a structured format optimized for both human review and machine processing. The generative AI tool may be prompted or fine-tuned to produce output in structured formats such as XML, JSON, or other machine-readable data structures. For example, the tool may generate an XML output with a structured format that includes matter number, patent number(s), claim number(s), and associated scope concepts.

The generative AI tool's prompt engineering may include specific instructions for output formatting, such as directives to organize concepts hierarchically, to include metadata such as confidence scores or source claim references, and to maintain consistent terminology throughout the structured output. The model may be fine-tuned on examples of well-formed outputs to enhance its ability to produce consistently structured results. This fine-tuning process may utilize supervised learning techniques where the model is trained on paired examples of patent claim inputs and their corresponding desired structured outputs of scope concepts.

This structured approach enables programmatic integration with other components of the patent management system 102 shown in FIG. 1, facilitating automated processing by downstream systems. The structured output may be presented via the user interface 502 shown in FIG. 5, where interactive elements allow users to examine the generated scope concepts. The display module 212 shown in FIG. 2 may render these structured outputs into visually intuitive representations such as tables, hierarchical trees, or network graphs that facilitate user comprehension of the complex relationships between claims and concepts.

At block 612, the generative AI tool may verify the produced scope concepts. For example, this may be done by the generative AI tool comparing the scope concepts to claim text, to each other, or otherwise automatically cross-checking the scope concepts. In some cases, the generative AI tool may receive input from a user regarding the produced scope concepts, and incorporate that input into the verification. The verification process may implement a multi-layered validation approach that includes both automated algorithmic verification and optional human-in-the-loop confirmation.

The automated verification may utilize non-generative AI algorithms which may implement rule-based heuristics to ensure that each identified scope concept has explicit textual support within the corresponding patent claims. This cross-verification may employ natural language understanding techniques to assess semantic alignment between the generated scope concepts and the original claim language, ensuring fidelity of representation. The verification may also include consistency checks across the portfolio to identify potential contradictions or redundancies in the scope concept designations.

For human verification, the generative AI tool may present verification interfaces through the display module 212 shown in FIG. 2, allowing patent practitioners to review, approve, modify, or reject the automatically generated scope concepts. User feedback received through the input module 214 may be incorporated into the verification process, potentially triggering refinement iterations by the generative AI tool 506 shown in FIG. 5. This feedback loop enables continuous improvement of the scope concept generation process and allows for expert domain knowledge to supplement the AI-driven analysis.

At block 614, the generative AI tool may display an interactive map of the scope concepts, such as including the claim text. The interactive map may be visual representation of the relationship between patent claims and their corresponding scope concepts. This map may be implemented as an interactive matrix which visually represents the relationship between common concepts and patent claim texts.

The interactive matrix may be rendered on the user interface 502 via the visual map 504 504 shown in FIG. 5. The map may implement various visualization techniques such as heat maps, network diagrams, or tabular formats with interactive cells that highlight or reveal additional information upon user interaction. The interactive nature of the map may enable users to filter, sort, or reorganize the displayed information according to various parameters such as concept prevalence, claim type, or document origin. The map may include hyperlinked elements that allow users to navigate between related claims, concepts, or documents within the patent portfolio 508.

The claim text may be displayed alongside the scope concepts, with highlighting mechanisms that visually connect specific claim language to the derived scope concepts. The interactive map may include user interface elements that initiate further actions, such as a scope modification interactive graphical user interface element allowing for dynamic refinement of the mapping as user understanding evolves.

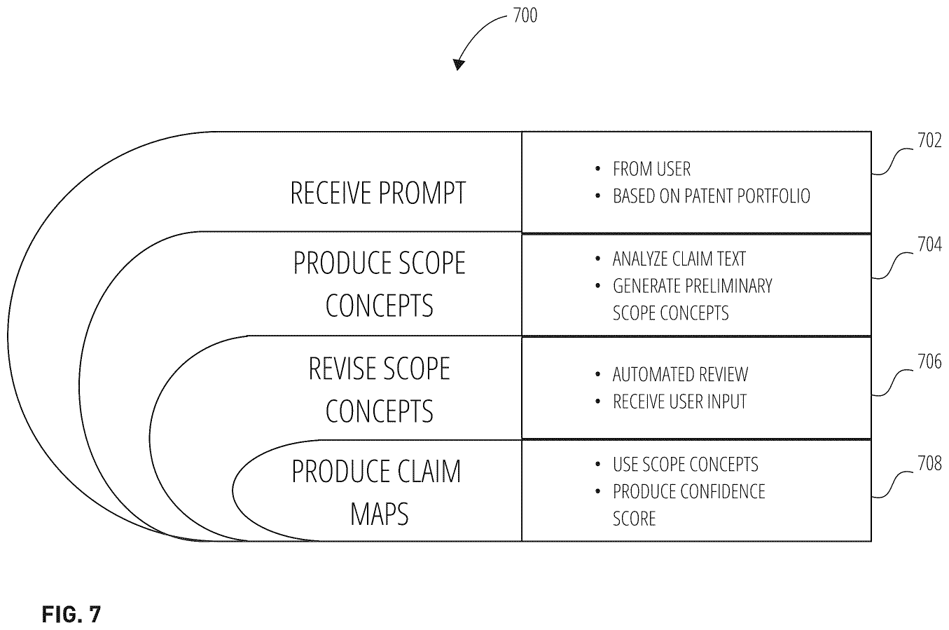

FIG. 7 is a block diagram of a generative artificial intelligence tool 700 process, according to various examples.

At block 702, the generative AI tool may receive a prompt, such as from a user, based on a patent portfolio of interest. The prompt may include natural language instructions specifying particular analysis objectives, desired output formats, or specific subsets of the patent portfolio to focus on. Such prompts may be submitted through a user interface element similar to user-interactive buttons 406 and 408 shown in FIG. 4.

At block 704, the generative AI tool may produce scope concepts related to the patent portfolio, such as by analyzing claim text and generating preliminary scope concepts. This step corresponds generally to the operations described in blocks 604, 606, 608, and 610 of FIG. 6.

At block 706, the generative AI tool may revise the scope concepts, such as through automated review, receiving user input, or both. This revision process may involve multiple iterations between automated system-driven refinements and user feedback (e.g., indicating a positive or negative view of an offered scope concept) to optimize the accuracy and relevance of the identified scope concepts.

At block 708, the generative AI tool may produce claim maps, using the scope concepts. In some cases, this may include confidence scores. The confidence scores may provide a quantitative measure of the AI tool's certainty in mapping particular scope concepts to specific patent claims, thereby enabling users to prioritize their review efforts on mappings that may require additional verification or refinement. These confidence scores may be visually represented within the interactive matrix described in block 614 of FIG. 6 through color gradients, numerical indicators, or other visual cues.

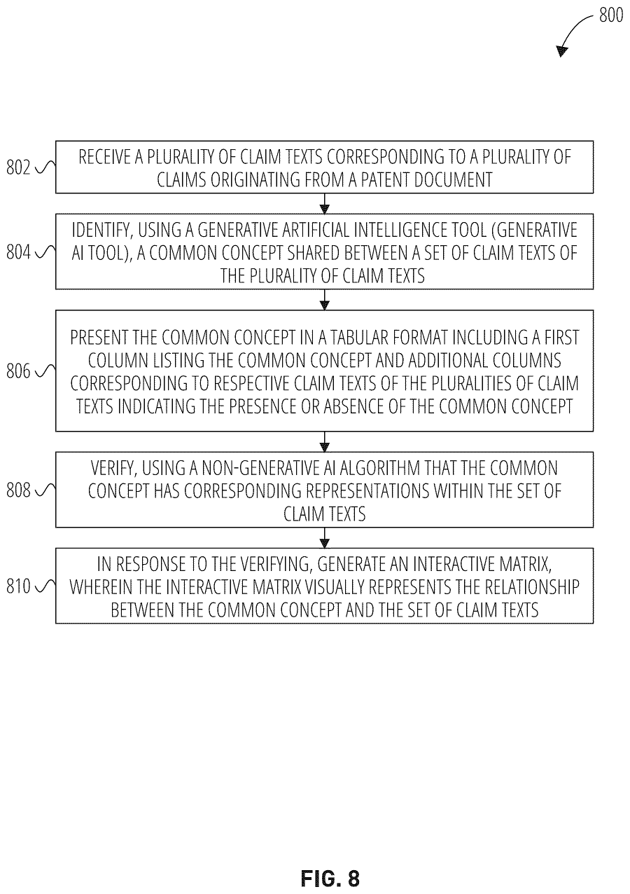

FIG. 8 is a flowchart illustrating a method to use a generative AI tool to identity a common concept, according to various examples. The method is represented as a set of blocks 802 to block 810 that describe operations of the method. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which executing the set of instructions, may configure the processing unit to perform the operations illustrated in FIG. 8. The processing unit may instruct other component of a computing device to carry out the set of instructions. For example, the processing unit may instruct a network device to transmit data to another computing device or the computing device may provide data over a display interface to present a user interface. In some examples, performance of the method may be split across multiple computing devices using a shared computing infrastructure (e.g., the processing unit encompasses multiple distributed computing devices).

In block 802, method 800 includes receiving a plurality of claim texts corresponding to a plurality of claims originating from a patent document. As described above with reference to FIG. 6, at block 602, a patent portfolio may be received by the generative AI tool. The generative AI tool may operate as an electronic service that receives data through an application programming interface (API) and may execute either locally on a user's computing device 104 or in a network environment, such as on application server 110 or web server 108 as illustrated in FIG. 1.

The method may further include receiving a patent portfolio that includes a plurality of patent documents, where the patent document is part of the plurality of patent documents. As discussed above with reference to FIG. 5, the patent portfolio 508 may include a multitude of patent applications, publications, or other such materials, including domestic documents, foreign documents, PCT documents, or all of the above. The generative AI tool 506 may interface with the patent portfolio 508 to access the plurality of patent documents.

The method may also include wherein receiving the plurality of claim texts includes automatically scraping patent claim text from the patent document.

As described above with reference to FIG. 6, at block 604, the generative AI tool may scrape claim text from the patent documents in the patent portfolio. The generative AI tool may retrieve the independent claims, dependent claims, or both, from gathered patent documents. In some cases, the claim text may be retrieved directly from one or more patent databases, such as the internal patent database 516 or third party patent database 518 shown in FIG. 5.

In block 804, method 800 identifies, using a generative artificial intelligence tool (generative AI tool), a common concept shared between a set of claim texts of the plurality of claim texts. As described above with reference to FIG. 6, at block 606, the generative AI tool may analyze the claim text and at block 608, determine one or more claim scope concepts based on its analysis of the claim language.

The method may also include wherein identifying, using the generative AI tool, the common concept includes iteratively analyzing the plurality of claim texts for text patterns across at least two claim texts of the plurality of claim texts. The method may also include where the generative AI tool is a transformer-based large language model. As described previously with reference to FIG. 6 at block 606, the analysis may utilize transformer-based mechanisms that calculate attention weights across token representations of the claim text, enabling the model to identify correlations between distant elements within the same claim and across different claims in the portfolio. The generative AI tool may implement topic modeling algorithms to cluster related terminology and identify thematic patterns across the claims.

The method may also include wherein identifying, using the generative AI tool, the common concept includes analyzing the plurality of claim texts for concept frequency across at least two claim texts of the plurality of claim texts. The tool may apply topic modeling algorithms to cluster related terminology and identify thematic patterns across the claims. This may involve calculating similarity metrics between claim elements using vector space representations of the claim text, allowing for quantitative measurement of conceptual overlap and frequency patterns across multiple patent claims.

The method may also include storing an indication of a relationship between the common concept and the set of claim texts. As described with reference to FIG. 5, the scope concepts 512 may be generated by the generative AI tool 506 based on the patent claims 510 in the patent portfolio 508 in conjunction with the ontology database 514. The structured output enables programmatic integration with other components of the patent management system 102, facilitating automated processing by downstream systems.

In block 806, method 800 presents the common concept in a tabular format, wherein the table includes a first column listing the common concept and additional columns corresponding to respective claim texts of the pluralities of claim texts indicating the presence or absence of the common concept. For example, there may be a column for each claim text and at the intersection of the common concept and the claim text a green highlight may mean the concept is present. Or text be used that says “present.” Other visual or textual indicators may be used without departing from the scope of this disclosure. Furthermore, with reference to FIG. 4, the another layout may be to place the scope concepts in a row that include the claim text. Thus, in FIG. 4, claim 1 has scope concepts [1] and [3] mapped for U.S. Pat. No. 9,999,999. The [1] and [3] may include the actual scope concept language in various examples.

In block 808, method 800 verifies, using a non-generative AI algorithm that the common concept has corresponding representations within the set of claim texts. This verification process implements a multi-layered validation approach that includes automated algorithmic verification. The non-generative AI algorithm may implement rule-based heuristics to ensure that each identified scope concept has textual support within the corresponding patent claims. This cross-verification may employ natural language understanding techniques to assess semantic alignment between the generated scope concepts and the original claim language, ensuring fidelity of representation.

The method may also include wherein verifying, using a non-generative AI algorithm that the common concept has corresponding representations within the set of claim texts including using a cosine similarity calculation between the common concept and a respective claim text of the plurality of claim texts. Cosine similarity may be employed to measure the angular distance between vector representations of the common concept and claim text, providing a numerical score between −1 and 1 that quantifies their semantic similarity. Additional verification metrics may include Levenshtein distance to measure the minimum number of single-character edits required to change one string into another, thereby assessing textual similarity between concept representations and claim language. The algorithm may also count verbatim root words present in both the common concept and claim text after stemming and lemmatization to remove inflectional endings. TF-IDF (Term Frequency-Inverse Document Frequency) scoring may be applied to weight the importance of terms based on their frequency in specific claims versus their commonality across the entire portfolio.

In block 810, method 800 in response to the verifying, generates an interactive matrix, wherein the interactive matrix visually represents the relationship between the common concept and the set of claim texts. As described above with reference to FIG. 6 at block 614, the generative AI tool may display an interactive map of the scope concepts, such as including the claim text. The interactive map may be implemented as an interactive matrix which visually represents the relationship between common concepts and patent claim texts. The interactive nature of the map may enable users to filter, sort, or reorganize the displayed information according to various parameters such as concept prevalence, claim type, or document origin.

The method may also include further includes receiving an indication that a cosine similarity value exceeds a threshold, and executing the generative AI tool a subsequent time to update the common concept. When similarity metrics such as cosine similarity between vector representations of the common concept and claim text exceed a predetermined threshold, the system may trigger a refinement iteration whereby the generative AI tool re-evaluates and updates the common concept to improve accuracy and representational fidelity. This feedback loop enables continuous improvement of the scope concept generation process based on objective similarity measurements.

The method may also include receiving a request, via the interactive matrix, to modify the common concept to a modified common concept for a patent claim text of the set of claim texts and updating a stored relationship of the patent claim text with the modified scope concept. As described with reference to FIG. 5, the user interface 502 may include a visual map 504 that allows for user interaction. The interactive matrix may include user interface elements that initiate further actions, such as a scope modification interactive graphical user interface element allowing for dynamic refinement of the mapping. When a user requests modification of a common concept through this interface, the system updates the stored relationship in the mapping database 208 as shown in FIG. 2, ensuring that the modified concept accurately reflects the user's understanding of the claim scope. This capability enables patent practitioners to refine and customize the automated analysis results based on their expert domain knowledge.

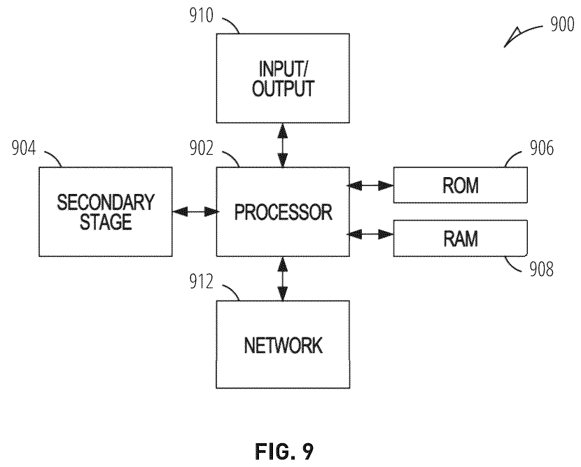

FIG. 9 is a block diagram of a typical, general-purpose computer 900 that may be programmed into a special purpose computer suitable for implementing one or more examples of the manifest record generating program disclosed herein. The manifest record generating program described above may be implemented on any general-purpose processing component, such as a computer with sufficient processing power, memory resources, and communications throughput capability to handle the necessary workload placed upon it. The computer 900 includes a processor 902 (which may be referred to as a central processor unit or CPU) that is in communication with memory devices including secondary storage 904, read only memory (ROM) 906, random access memory (RAM) 908, input/output (I/O) devices 910, and network connectivity devices 912. The processor 902 may be implemented as one or more CPU chips or may be part of one or more application specific integrated circuits (ASICs).

The secondary storage 904 is typically comprised of one or more disk drives or tape drives and is used for non-volatile storage of data and as an over-flow data storage device if RAM 908 is not large enough to hold all working data. Secondary storage 904 may be used to store programs that are loaded into RAM 908 when such programs are selected for execution. The ROM 906 is used to store instructions and perhaps data that are read during program execution. ROM 906 is a non-volatile memory device that typically has a small memory capacity relative to the larger memory capacity of secondary storage 904. The RAM 908 is used to store volatile data and perhaps to store instructions. Access to both ROM 906 and RAM 908 is typically faster than to secondary storage 904.

The devices described herein may be configured to include computer-readable non-transitory media storing computer readable instructions and one or more processors coupled to the memory, and when executing the computer readable instructions configure the computer 900 to perform method steps and operations described above with reference to FIG. 3 to FIG. 9. The computer-readable non-transitory media includes all types of computer readable media, including magnetic storage media, optical storage media, flash media and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The examples herein are capable of other examples, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled”, and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated examples may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative examples may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the examples disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

What is claimed is:

1. A method comprising:
receiving a plurality of claim texts corresponding to a plurality of claims originating from a patent document;
identifying, using a generative artificial intelligence tool (generative AI tool), a common concept shared between a set of claim texts of the plurality of claim texts;
presenting the common concept in a tabular form including a first column listing the common concept and additional columns corresponding to respective claim texts of the pluralities of claim texts indicating a presence or absence of the common concept;
verifying, using a non-generative AI algorithm that the common concept has corresponding representations within the set of claim texts; and
in response to the verifying, generating an interactive matrix, wherein the interactive matrix visually represents a relationship between the common concept and the set of claim texts.

2. The method of claim 1, further comprising:
receiving a patent portfolio comprising a plurality of patent documents, wherein the patent document is part of the plurality of patent documents.

3. The method of claim 1, wherein receiving the plurality of claim texts comprises automatically scraping patent claim text from the patent document.

4. The method of claim 1, wherein identifying, using the generative AI tool, the common concept comprises iteratively analyzing the plurality of claim texts for text patterns across at least two claim texts of the plurality of claim texts.

5. The method of claim 1, wherein identifying, using the generative AI tool, the common concept comprises analyzing the plurality of claim texts for concept frequency across at least two claim texts of the plurality of claim texts.

6. The method of claim 1, wherein the generative AI tool is a transformer-based large language model.

7. The method of claim 1, wherein verifying, using a non-generative AI algorithm that the common concept has corresponding representations within the set of claim texts includes using a cosine similarity calculation between the common concept and a respective claim text of the plurality of claim texts

8. The method of claim 7, further comprising:
receiving an indication that a cosine similarity value exceeds a threshold; and
based on receiving the indication, executing the generative AI tool a subsequent time to update the common concept.

9. The method of claim 1, storing an indication of a relationship between the common concept and the set of claim texts.

10. The method of claim 1, further comprising:
receiving a request, via the interactive matrix, to modify the common concept to a modified common concept for a patent claim text of the set of claim texts; and
updating a stored relationship of the patent claim text with the modified common concept.

11. The method of claim 1, wherein the interactive matrix includes highlighting a patent term in the set of claim texts associated with the common concept.

12. A system comprising:
a processing unit; and
a storage device comprising instructions, which when executed by the processing unit, configure the processing unit to perform operations including:
receiving a plurality of claim texts corresponding to a plurality of claims originating from a patent document;
identifying, using a generative artificial intelligence tool (generative AI tool), a common concept shared between a set of claim texts of the plurality of claim texts;
presenting the common concept in a tabular form including a first column listing the common concept and additional columns corresponding to respective claim texts of the pluralities of claim texts indicating a presence or absence of the common concept;
verifying, using a non-generative AI algorithm that the common concept has corresponding representations within the set of claim texts; and
in response to the verifying, generating an interactive matrix, wherein the interactive matrix visually represents a relationship between the common concept and the set of claim texts.

13. The system of claim 12, wherein the instructions, which, when executed by the processing unit, further configure the processing unit to perform operations comprising:
receiving a patent portfolio comprising a plurality of patent documents, wherein the patent document is part of the plurality of patent documents.

14. The system of claim 12, wherein receiving the plurality of claim texts comprises automatically scraping patent claim text from the patent document.

15. The system of claim 12, wherein identifying, using the generative AI tool, the common concept comprises iteratively analyzing the plurality of claim texts for text patterns across at least two claim texts of the plurality of claim texts.

16. The system of claim 12, wherein identifying, using the generative AI tool, the common concept comprises analyzing the plurality of claim texts for concept frequency across at least two claim texts of the plurality of claim texts.

17. The system of claim 12, wherein the generative AI tool is a transformer-based large language model.

18. The system of claim 12, wherein verifying, using a non-generative AI algorithm that the common concept has corresponding representations within the set of claim texts includes using a cosine similarity calculation between the common concept and a respective claim text of the plurality of claim texts

19. The system of claim 18, wherein the instructions, which when executed by the processing unit, further configure the processing unit to perform operations comprising:
receiving an indication that a cosine similarity value exceeds a threshold; and
based on receiving the indication, executing the generative AI tool a subsequent time to update the common concept.

20. A non-transitory computer-readable medium comprising instructions, which when executed by a processing unit, configure the processing unit to perform operations comprising:
receiving a plurality of claim texts corresponding to a plurality of claims originating from a patent document;
identifying, using a generative artificial intelligence tool (generative AI tool), a common concept shared between a set of claim texts of the plurality of claim texts;
presenting the common concept in a tabular form including a first column listing the common concept and additional columns corresponding to respective claim texts of the pluralities of claim texts indicating a presence or absence of the common concept;
verifying, using a non-generative AI algorithm that the common concept has corresponding representations within the set of claim texts; and
in response to the verifying, generating an interactive matrix, wherein the interactive matrix visually represents a relationship between the common concept and the set of claim texts.
